(19) United States
(12) Patent Application Publication
(10) Pub. No.: US 2018/0011495 A1
(43) Pub. Date: Jan. 11, 2018

(54) ROUTE SEARCH METHOD, ROUTE SEARCH SYSTEM, NON-TRANSITORY COMPUTER-READABLE STORAGE MEDIUM, AND WORK VEHICLE

(71) Applicant: Kubota Corporation, Osaka-shi (JP)

(72) Inventors: Kazuo SAKAGUCHI, Amagasaki (JP); Yasuhisa UOYA, Amagasaki (JP); Takafumi MORISHITA, Amagasaki (JP); Kotaro YAMAGUCHI, Amagasaki (JP); Hiroki SUGA, Amagasaki (JP); Megumi SUZUKAWA, Amagasaki (JP)

(73) Assignee: Kubota Corporation, Osaka-shi (JP)

(21) Appl. No.: 15/385,774

(22) Filed: Dec. 20, 2016

(30) Foreign Application Priority Data
Jul. 8, 2016 (JP) 2016-135848

(51) Int. Cl. G05D 1/02; A01B 69/04; A01B 76/00; G01C 21/34

(52) U.S. Cl. CPC G05D 1/0212; G01C 21/34; G05D 1/0276; A01B 69/008; A01B 76/00; G05D 2201/0201

(57) ABSTRACT

A route search system for a work vehicle includes a receiver, a processor, and a controller. The receiver is to obtain a reference position of the work vehicle. The processor is to define, as a search area, an area around a vehicle reference point in a plan view. The vehicle reference point indicates the reference position of the work vehicle. The controller is to determine a guidance travel route along which the work vehicle is to travel and which is closest to the vehicle reference point in the search area among travel route candidates stored in a memory.

### CROSS-REFERENCE TO RELATED APPLICATIONS

The present application claims priority under 35 U. S. C. §119 to Japanese Patent Application No. 2016-135848, filed Jul. 8, 2016. The contents of this application are incorporated herein by reference in their entirety.

### BACKGROUND OF THE INVENTION

### Field of the Invention

The present invention relates to a route search method, a route search system, a non-transitory computer-readable storage medium, and work vehicle.

### Discussion of the Background

Japanese Patent Application Laid-open No. 2016-021890 discloses a rice transplanter that generates a target route parallel to a teaching route generated by a teaching route generator, based on positional information measured by a GPS device to autonomously travel on the target route. When an operator operates an automatic turning device, this rice transplanter automatically turns toward a next target route, and, in succession to this, the rice transplanter autonomously travels on the next target route.

Japanese Patent Application Laid-open No. 2008-131880 discloses a rice transplanter configured to generate a target route parallel to a teaching route generated based on positional information measured by a GPS unit, to automatically turn toward a next target route, and to autonomously travel on the next target route.

### SUMMARY OF THE INVENTION

According to one aspect of the present invention, a route search system for a work vehicle includes a receiver, a processor, and a controller. The receiver is to obtain a reference position of the work vehicle. The processor is to define, as a search area, an area around a vehicle reference point in a plan view. The vehicle reference point indicates the reference position of the work vehicle. The controller is to determine a guidance travel route along which the work vehicle is to travel and which is closest to the vehicle reference point in the search area among travel route candidates stored in a memory.

According to another aspect of the present invention, a work vehicle includes a memory, a position calculator, a processor, a controller, and a deviation calculator. The memory is to store travel routes. The position calculator is to calculate a reference position of work vehicle based on positioning data. The processor is to define as a search area, an area around a vehicle reference point in a plan view. The vehicle reference point indicates the reference position of the work vehicle. The controller is to determine a guidance travel route along which the work vehicle is to travel and which is closest to the vehicle reference point in the search area among travel routes stored in the memory. The deviation calculator is to calculate a deviation between the guidance travel route and the reference position.

According to further aspect of the present invention, a route search method for a work vehicle includes obtaining a reference position of the work vehicle. An area around a vehicle reference point in a plan view is defined as a search area. The vehicle reference point indicates the reference position. Positional relationships among travel route candidates stored in a memory, the reference position of the work vehicle, and the search area are calculated. A guidance travel route along which the work vehicle is to travel is determined from the travel route candidates based on the positional relationships.

According to further aspect of the present invention, a non-transitory computer-readable storage medium has program code stored therein which, when executed by a computer, causes the computer to perform a route search method for a work vehicle. The route search method includes obtaining a reference position of the work vehicle. An area around a vehicle reference point in a plan view is defined as a search area. The vehicle reference point indicates the reference position of the work vehicle. A guidance travel route along which the work vehicle is to travel and which is closest to the vehicle reference point in the search area is determined among the travel route candidates stored in a memory.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an explanatory view illustrating a search area set around a work vehicle, and travel routes set in a work field.

FIGS. 2A to 2F are explanatory views of examples each illustrating a control rule for selecting a guidance travel route based on positional relationships among a group of travel route candidates, an own position, and a search area.

FIG. 3 is a side view of a tractor equipped with a tilling machine, according to a specific exemplary embodiment of the work vehicle.

FIG. 4 is a functional block diagram illustrating a control system of the tractor.

FIG. 5 is a flowchart illustrating a route search routine.

FIGS. 6A to 6C are schematic views of examples each illustrating positional relationships among a group of travel route candidates, an own position, and a search area.

FIGS. 7A to 7C are schematic views of examples each illustrating positional relationships among a group of travel route candidates, an own position, and a search area.

FIGS. 8A and 8B are schematic views of examples each illustrating positional relationships among a group of travel route candidates, an own position, and a search area.

### DESCRIPTION OF THE EMBODIMENTS

The embodiment(s) will now be described with reference to the accompanying drawings, wherein like reference numerals designate corresponding or identical elements throughout the various drawings.

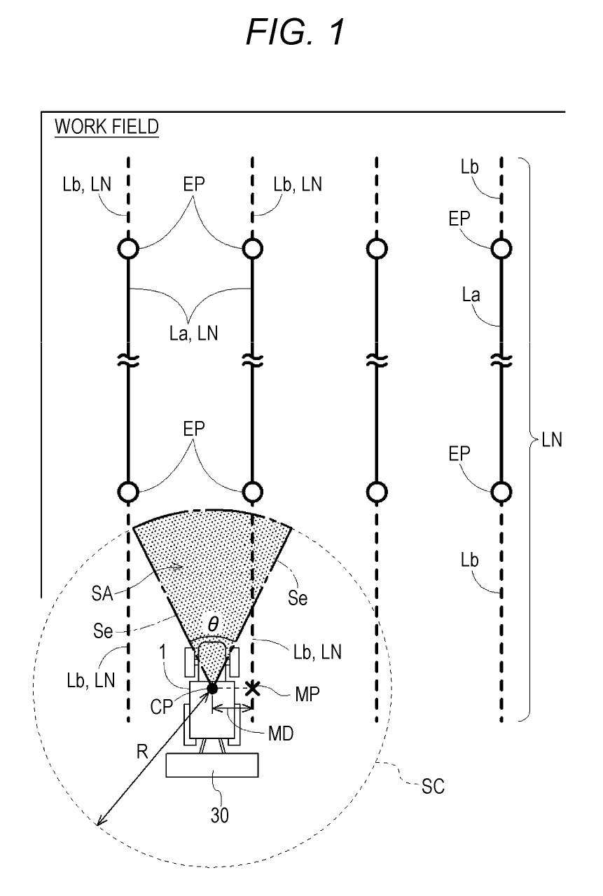

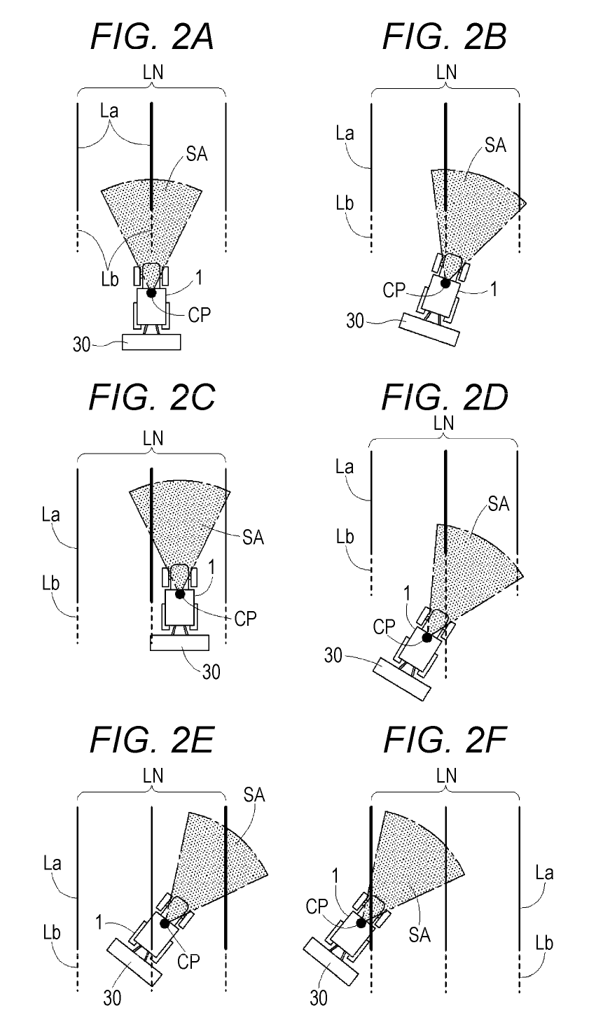

Prior to describing a specific exemplary embodiment of the present invention, definitions of terms used in the embodiment of the present invention and principles of a route search will now be described herein with reference to FIGS. 1 and 2A to 2F. FIG. 1 schematically illustrates a work vehicle including a vehicle body 1 and a work device 30 mounted on the vehicle body 1, and a work field in which this work vehicle travels. Guidance travel routes LN that are set in the work field and are to be targeted by the work vehicle are illustrated in here as a group of straight travel routes extending in parallel each other. Each of the travel routes LN are expressed with an equation. The travel routes LN each include an actual travel route portion La functioning as an actual travel route, and extended route portions Lb extended from the actual travel route portion La. The actual travel route portion La is defined by end points EP at both ends. Each of the travel routes LN constituting the group of travel routes is not limited to a straight line in a strict sense, but may be a curve. The curves at that time may be curves expressed by curve equations, or may be aggregations of pieces of straight lines joined together while being bent. The travel routes LN may not be disposed in parallel each other, but may be disposed in a nonparallel manner, for example, some travel routes LN are disposed to intersect with other travel routes LN. A work vehicle sometimes travels while working (hereinafter referred to as actual work travelling), and sometimes travels without working where no directional change is included (hereinafter referred to as no work travelling). In this specification, however, a term such as “when a work vehicle travels” refers to either or both meanings, i.e., actual work travelling and/or no work travelling.

Although an own vehicle reference point CP is set, as a predetermined reference point of the work vehicle, at almost a center position of the vehicle body 1, the own vehicle reference point CP can be set at various positions such as a ground work position of the work device 30. A distance in a radial direction from the own vehicle reference point CP is referred to as a search distance R. That is, an area inside a circle SC having a radius R around the own vehicle reference point CP satisfies an area within the search distance R. In the example shown in FIG. 1, an area around an own vehicle reference point CP, i.e., a fan like area (fan shaped area) having a central angle of approximately 45° and spreading in a travel direction of an own vehicle around the own vehicle reference point CP, is further set as a search area SA. This fan shape has a radius that matches with the search distance R, and its sides are denoted with reference sign Se. A central angle θ of the fan shape may be expanded to 180°. Any desired shape may be applied to the search area SA. However, the shape may advantageously be as simple as possible in terms of computation. Even if an own position (a reference position of the work vehicle) calculated based on positioning data sent from a satellite positioning module such as a GPS or a GNNS (an example positioning module) and a position of an own vehicle reference point CP (a vehicle reference point CP) differ, the positions can be corrected with a simple computation. Thus, the positions can be regarded substantially as identical. To provide a simple description, an own position and an own vehicle reference point CP are described as identical herein. An own vehicle reference point CP is therefore sometimes referred to simply as an own position. Since a perpendicular line from an own vehicle reference point CP (own position) toward a travel route LN defines a shortest distance MD between the own vehicle reference point CP and the travel route LN, a coordinate position indicating a node between this perpendicular line and the travel route LN is defined as a shortest position MP.

A group of travel routes set in a work field, i.e., a group of straight lines developed in a memory in terms of computation, becomes a plurality of travel route candidates to be handled by this route search program. A positional relationship between an own vehicle reference point CP and a search area SA is calculated, and a guidance travel route to be targeted by the work vehicle is selected from among the plurality of travel route candidates, based on the calculated positional relationship.

FIGS. 2A to 2F show, in each example, travel route candidates configured by three travel routes LN, and a work vehicle in various positions (orientations) relative to the travel route candidates. The work vehicle is added with an own vehicle reference point CP indicated with a black dot, and a fan shaped search area SA. The travel routes LN linearly extend in parallel each other from the top to bottom of the view, and are each indicated with an actual travel route portion La on an upper side and an extended route portion Lb on a lower side. Ones of the travel routes LN shown with bold lines are adopted as guidance travel routes.

In a basic route search method according to the embodiment of the present invention, a travel route candidate that is closest to an own position (own vehicle reference point) CP in a search area SA is selected as a guidance travel route to be targeted by the work vehicle. In search areas SA shown in FIGS. 2A to 2F, ones of the travel routes LN, which substantially lie closest to the own vehicle reference points CP are also adopted as guidance travel routes.

FIGS. 2A to 2F show examples of rules, i.e., Examples (a) to (f), used as other basic route search methods according to the embodiment of the present invention, for selecting a guidance travel route from among three travel route candidates based on positional relationships among travel route candidates, an own vehicle reference point CP of the work vehicle, and a search area SA.

### Example (a) in FIG. 2A

A travel direction of the work vehicle matches with an extending direction of travel routes LN. A search area SA captures an actual travel route portion La of a travel route candidate at a center. An own vehicle reference point CP lies on an extended route portion Lb of the travel route candidate at the center. When the work vehicle keeps advancing, the work vehicle reaches the actual travel route portion La. Thus, the travel route candidate at the center is selected as a guidance travel route.

### Example (b) in FIG. 2B

A travel direction of the work vehicle is slightly inclined toward an extending direction of travel routes LN. A search area SA captures an actual travel route portion La of a travel route candidate at a center and an actual travel route portion La of a travel route candidate on a right. An own vehicle reference point CP lies on an extended route portion Lb of the travel route candidate at the center. When the work vehicle advances along the travel route candidate at the center with a steering wheel slightly steered, the work vehicle reaches the actual travel route portion La. Thus, the travel route candidate at the center is selected as a guidance travel route.

### Example (c) in FIG. 2C

Although a travel direction of the work vehicle matches with an extending direction of travel routes LN, the work vehicle lies between a travel route candidate at a center and a travel route candidate on a right. A search area SA captures an actual travel route portion La of the travel route candidate at the center and an actual travel route portion La of the travel route candidate on the right. Whichever of the travel route candidates, a shortest position MP lies on the actual travel route portion La. Since a shortest distance MD is a distance between the work vehicle and the travel route candidate at the center, the travel route candidate at the center is selected as a guidance travel route.

### Example (d) in FIG. 2D

A travel direction of the work vehicle is largely inclined in an extending direction of travel routes LN. A search area SA captures an actual travel route portion La of a travel route candidate at a center and an extended route portion Lb of a travel route candidate on a right. Whichever of the travel route candidates, a shortest position MP lies on either an extended route portion Lb of the travel route candidate at the center or the extended route portion Lb of the travel route candidate on the right. For a shortest distance MD, a distance between the work vehicle and the travel route candidate at the center is shorter. A node between the search area SA and the travel route candidate at the center lies on an actual travel route portion La of the travel route candidate at the center, while a node between the search area SA and the travel route candidate on the right lies on an extended route portion Lb of the travel route candidate on the right. The travel route candidate at the center is selected as a guidance travel route.

### Example (e) in FIG. 2E

A travel direction of the work vehicle is largely inclined in an extending direction of travel routes LN. A search area SA captures an actual travel route portion La of a travel route candidate on a right. Whichever of travel route candidates, a shortest position MP lies on the actual travel route portion La of the travel route candidate on the right, or either actual travel route portions La of other travel route candidates. For a shortest distance MD, a distance between the work vehicle and the travel route candidate at a center is shorter. An own vehicle reference point CP of the work vehicle passes through the travel route candidate at the center. A node between the search area SA and the travel route candidate on the right lies on an actual travel route portion La of the travel route candidate on the right. The travel route candidate on the right is selected as a guidance travel route.

### Example (f) in FIG. 2F

A travel direction of the work vehicle is largely inclined in an extending direction of travel routes LN. A search area SA captures an actual travel route portion La of a travel route candidate on a left and an actual travel route portion La of a travel route candidate at a center. Whichever of the travel route candidates, a shortest position MP lies on either the actual travel route portions La of the travel route candidates at the center and on the left. For a shortest distance MD, a distance between the work vehicle and the travel route candidate on the left is shorter. A node between the search area SA and the travel route candidate on the left and a node between the search area SA and the travel route candidate at the center lie on the respective actual travel route portions La. The travel route candidate on the left is selected as a guidance travel route.

By combining the above described rules, a selection algorithm for selecting a guidance travel route from among a plurality of travel route candidates based on positional relationships among the travel route candidates, an own vehicle reference point CP of the work vehicle, and a search area SA can be constructed in accordance with a type of the work vehicle or a type of a work field.

Once a guidance travel route is selected, a deviation between the guidance travel route and an own position is then calculated to steer the work vehicle so as to reduce this deviation. Thus the work vehicle travels as planned. The work vehicle may be steered manually or automatically. Since, when the work vehicle is steered manually, a calculated deviation is notified visually or audibly to a driver, the driver can steer the work vehicle by referring to the notification.

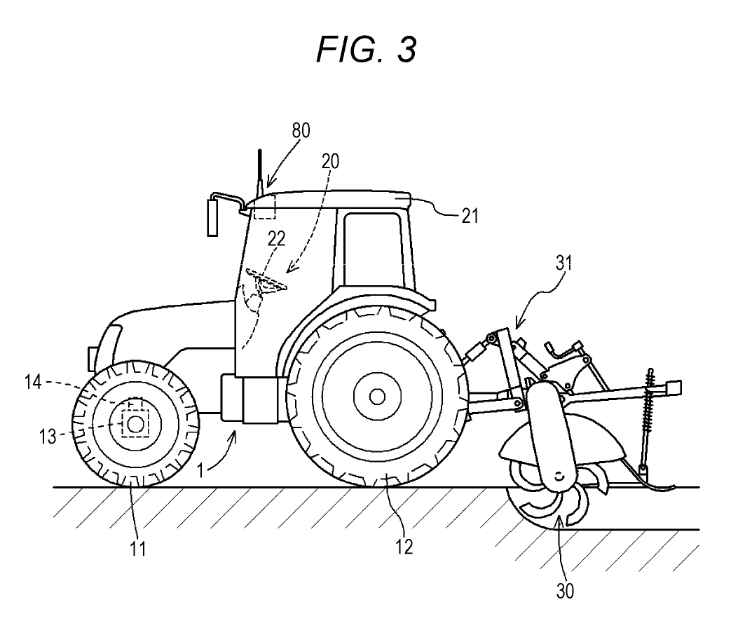

Next, a work vehicle according to the specific exemplary embodiment of the present invention will now be described herein. In this exemplary embodiment, as shown in FIG. 3, the work vehicle is a tractor that can be equipped with the work device 30, and that travels and works in a field (work field) separated by ridges as boundaries. This tractor is provided with an operation unit 20 at a center of the vehicle body 1 supported by front wheels 11 and rear wheels 12. At a rear of the vehicle body 1, the work device 30 that is a rotary tilling machine is mounted via a hydraulic lifting mechanism 31. The front wheels 11 function as steering control wheels through which the tractor changes a travel direction when a steering angle of the steering control wheels is changed. The steering angle of the front wheels 11 is changed by an operation of a steering mechanism 13. The steering mechanism 13 includes a steering motor 14 for automatic steering. For manual travelling, the front wheels 11 can be steered by operating a steering wheel 22 disposed on the operation unit 20. In a cabin 21 of the tractor, a satellite positioning module 80 configured as a GNSS module is provided. As a component of the satellite positioning module 80, a satellite antenna for receiving GPS signals and GNSS signals is attached at a ceiling area of the cabin 21. The satellite positioning module 80 may include an inertial navigation module incorporated with a gyro acceleration sensor and a magnetic director sensor for complementing satellite navigation. The inertial navigation module may also be provided in a different location from the satellite positioning module 80.

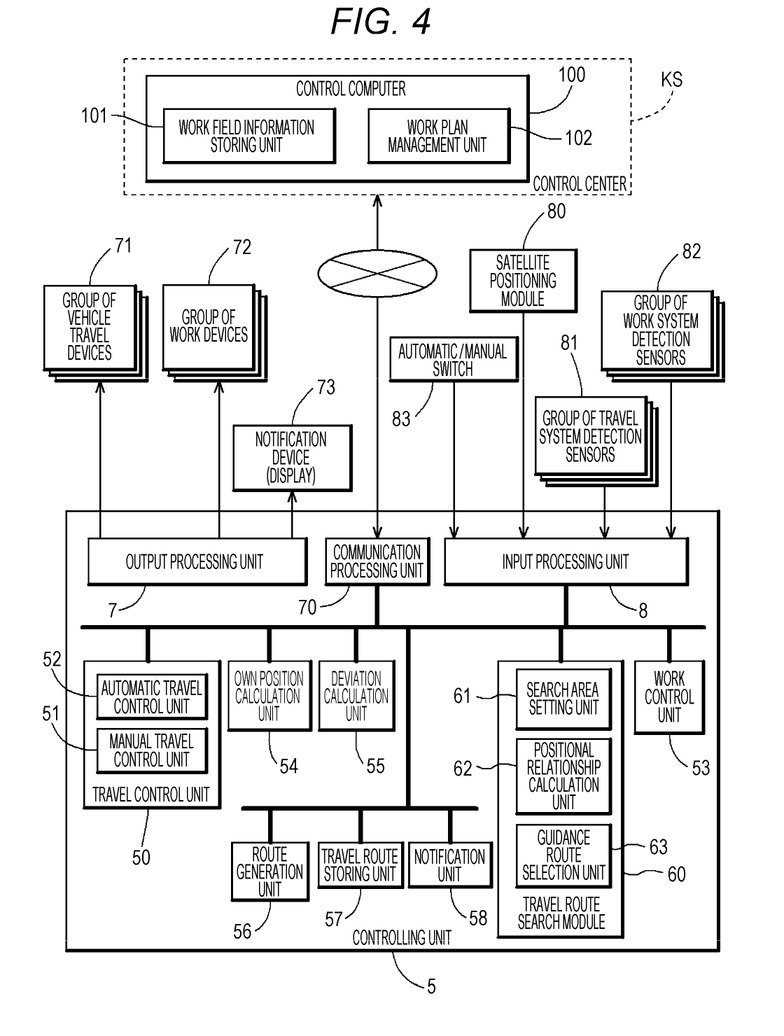

FIG. 4 illustrates a control system constructed in this tractor. This control system is configured to achieve the route search technique according to the embodiment of the present invention described with reference to FIGS. 1 and 2A to 2F. A controlling unit 5 (circuitry 5) that is a core element of this control system includes an output processing unit 7 and an input processing unit 8, which respectively function as input and output interfaces, and a communication processing unit 70. The output processing unit 7 is connected with, for example, a group of vehicle travel devices 71, a group of work devices 72, and a notification device 73. The group of vehicle travel devices 71 includes the steering motor 14 and, although not shown in the drawings, devices to be controlled for allowing the work vehicle to travel, such as a transmission mechanism and an engine unit. The group of work devices 72 includes, for example, a drive mechanism for the work device 30, and a lifting mechanism 31 for raising and lowering the work device 30. The communication processing unit 70 has a function of sending data processed by the controlling unit 5 to a management computer 100 constructed in a control center KS in a remote location, and of receiving various kinds of data from the management computer 100. The notification device 73 includes a display, lamps, and a speaker. The display in particular shows travel routes generated by the controlling unit 5. The lamps and the speaker are used to notify a driver and an operator of various desired kinds of information such as travel precautions and a degree of deviation from a target travel route when the work vehicle is automatically steered. Signals are transmitted between the notification device 73 and the output processing unit 7 in a wired or wireless manner.

The input processing unit 8 is coupled to, for example, the satellite positioning module 80, a group of travel system detection sensors 81, a group of work system detection sensors 82, and an automatic/manual switch 83. The group of travel system detection sensors 81 includes sensors for detecting travel states such as an engine speed and a transmission state. The group of work system detection sensors 82 includes, for example, sensors for detecting a position and an inclination of the work device 30, and sensors for detecting workloads and the like. The automatic/manual switch 83 is a switch for selecting either an automatic travel mode for travelling with automatic steering or a manual travel mode for travelling with manual steering. For example, by operating the automatic/manual switch 83, the mode of the work vehicle travelled in the automatic travel (automatic steering) mode can be switched to the manual travel (manual steering) mode. On the other hand, by operating the automatic/manual switch 83, the mode of the work vehicle travelled in the manual travel (manual steering) mode can be switched to the automatic travel (automatic steering) mode.

In the controlling unit 5, a travel route search module 60 for executing a route search to find a guidance travel route to be targeted by the work vehicle is constructed as described with reference to FIGS. 1 and 2A to 2F. The controlling unit 5 also includes a travel control unit 50, a work control unit 53, an own position calculation unit 54 (a position calculator 54), a deviation calculation unit 55 (a deviation calculator 55), a route generation unit 56, a travel route storing unit 57 (a memory 57), and a notification unit 58.

Since the automatic travel (automatic steering) mode and the manual travel (manual steering) mode are both configured to be available in this tractor for travelling, the travel control unit 50 for controlling the group of vehicle travel devices 71 includes a manual travel control unit 51 and an automatic travel control unit 52. In accordance with operations by the driver, the manual travel control unit 51 controls the group of vehicle travel devices 71. The automatic travel control unit 52 generates an automatic steering instruction and outputs the automatic steering instruction to the steering motor 14 via the output processing unit 7 so as to cause the vehicle body 1 to travel along the guidance travel route selected by the travel route search module 60. To control movement of the work device 30, the work control unit 53 provides control signals to the group of work devices 72.

Based on the positioning data sent from the satellite positioning module 80, the own position calculation unit 54 calculates an own position. The deviation calculation unit 55 calculates a deviation between a guidance travel route selected by the travel route search module 60 and an own position (including a difference in coordinate position and a difference in direction), and provides the calculated deviation to the automatic travel control unit 52. The automatic travel control unit 52 generates an automatic steering instruction to control the steering motor 14 via the output processing unit 7 so as to reduce this deviation.

The route generation unit 56 generates route data specifying a travel route to be handled as a travel route candidate by the travel route search module 60. This route data is generated based on external shape data obtained from work field map data included in work field information. The route data can also be generated through an entry made by a driver or a manager. The work field information can be extracted from a work field information storing unit 101 of the management computer 100 installed in the control center KS in the remote location, and can be downloaded into the controlling unit 5. The route data itself can also be controlled by the management computer 100 so as to be included in the work field information. That is, although the route generation unit 56 is constructed in the controlling unit 5 in FIG. 4, the route generation unit 56 may be constructed in the management computer 100 so that route data generated by the management computer 100 is downloaded into the controlling unit 5 via the communication processing unit 70. Although not shown in FIG. 4, the route generation unit 56 may also be constructed in a communication terminal such as a tablet computer held by, for example, a supervisor supervising this tractor being operated so that route data generated by the communication terminal is downloaded into the controlling unit 5 via the communication processing unit 70. In either case, a travel route that is route data obtained by the controlling unit 5 is stored in the travel route storing unit 57. A work plan describing travelling work in a specified field may also be downloaded from a work plan management unit 102 of the management computer 100 into the controlling unit 5. The work vehicle is thus adjusted beforehand so as to operate based on the work plan.

The notification unit 58 generates a notification signal (display data or voice data) for notifying the driver and the supervisor of necessary information through the notification device 73 including the display and the speaker. In this exemplary embodiment, the notification unit 58 has a display data generation function of generating data for graphically showing on the display a work route stored in the travel route storing unit 57 and a deviation calculated by the deviation calculation unit 55.

The travel route search module 60 is substantially constructed with a computer program, and can execute controls described with reference to FIGS. 1 and 2A to 2F. To this end, the travel route search module 60 includes a search area setting unit 61 (a processor 61), a positional relationship calculation unit 62 (a relationship calculator 62), and a guidance route selection unit 63 (a controller 63). The search area setting unit 61 sets a shape of the search area SA shown in FIG. 1, and a position of the search area SA relative to the vehicle body 1. Since the search area SA has a fan shape in this exemplary embodiment, the central angle θ of the fan shape, and a side length Se of the fan shape are set. A center point of this fan shape is regarded as an own vehicle reference point CP, and is handled as an own position. The side length Se of the fan shape and a search distance R are identical. The positional relationship calculation unit 62 calculates positional relationships between a plurality of travel route candidates read from the travel route storing unit 57 and an own position obtained by the own position calculation unit 54. The guidance route selection unit 63 selects, from among the travel route candidates, a guidance travel route for guiding an own vehicle, based on the positional relationships calculated by the positional relationship calculation unit 62, and provides the guidance travel route to the deviation calculation unit 55.

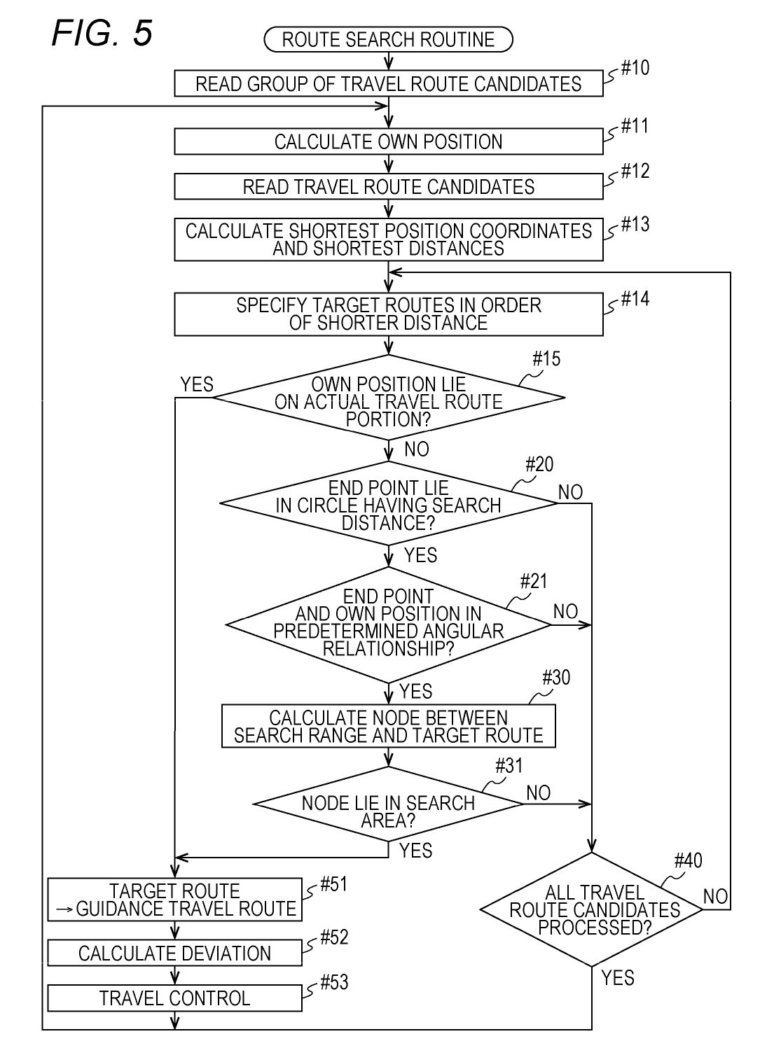

The guidance route selection unit 63 can combine and execute the control rules such as Examples (a) to (f) described with reference to FIGS. 2A to 2F. A route search routine to be executed by the guidance route selection unit 63 by combining these control rules will be described herein with reference to the flowchart shown in FIG. 5.

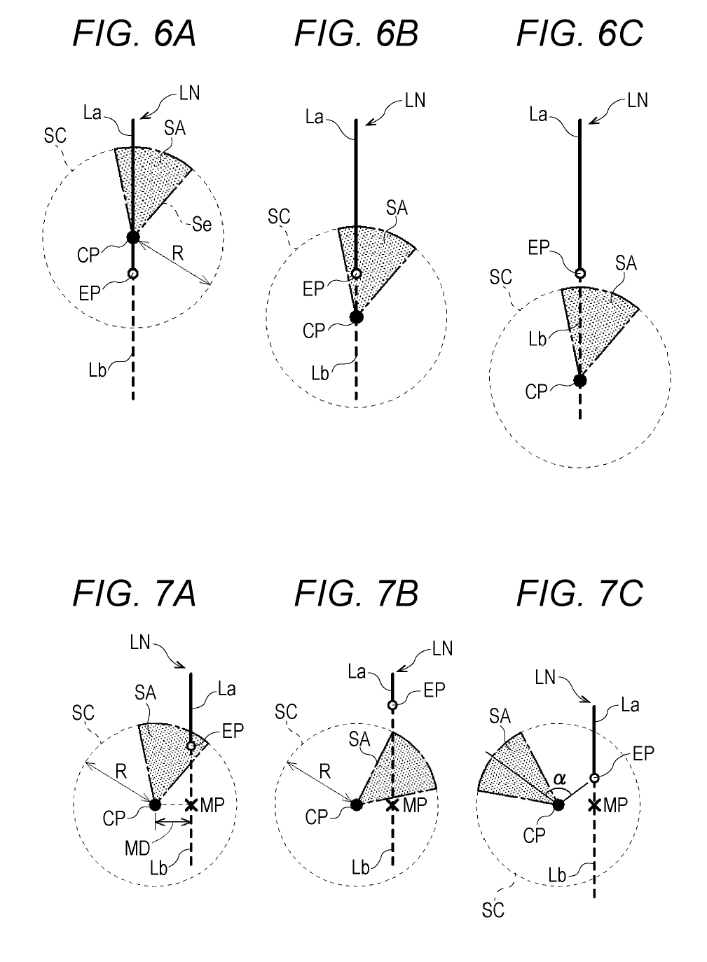

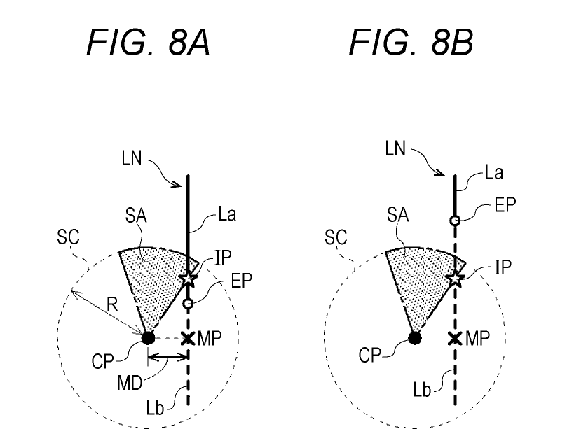

To help understanding of the flowchart, positional relationships among own positions, search areas SA, and travel routes are schematically illustrated in FIGS. 6A to 6C, 7A to 7C, 8A, and 8B. These positional relationships are used as selection conditions in selecting a guidance route. In FIGS. 6A to 6C, each own vehicle reference point (own position) CP lies on a travel route LN. In FIG. 6A, the own vehicle reference point CP lies on an actual travel route portion La. In FIGS. 6B and 6C, the own vehicle reference points CP respectively lie on an extended route portion Lb. In FIG. 6B, an end point EP is within a search area SA. In FIG. 6C, an end point EP is outside a search area SA. In FIGS. 7A to 7C, each own vehicle reference point (own position) CP lies away from a travel route LN, where shortest distances MD and shortest positions MP are shown. In FIG. 7A, an end point EP corresponding to the shortest position MP lies within a search area SA. In FIG. 7B, an end point EP lies outside a search distance R. In FIG. 7C, an angle α between a straight line joining the own vehicle reference point CP and an end point EP and a travel direction of the vehicle body 1 exceeds a predetermined angle of 90°. FIGS. 8A and 8B show sides Se of search areas SA and nodes IP of travel routes (star marks in FIGS. 8A and 8B). In FIG. 8A, the node IP lies on an actual travel route portion La. In FIG. 8B, the node IP lies on an extended route portion Lb.

When a route search routine is called, travel route data is read as a group of travel route candidates from the travel route storing unit 57 (#10). Next, an own position calculated by the own position calculation unit 54 is obtained (#11). A plurality of travel routes is extracted and read as travel route candidates from the travel route storing unit 57 (#12). All travel routes to be developed in an entire area or a partial area of a work field may be read as travel route candidates. This process step in this case is handled as an initial process. Travel routes may otherwise be added with attribute values on un-finished and finished operations and travel directions, and the routine may be configured so that travel routes that are not subject to selection will not be extracted.

Next, perpendicular lines passing through the own position toward travel route candidates are obtained, and then shortest positions MP (coordinate value) and shortest distances MD are obtained (#13). In an order of shorter distances, the shortest distances MD are specified as target travel route candidates (hereinafter simply referred to as target routes) for later processes of calculating positional relationships (#14). As a first step of selecting a route, a determination is made as to whether the own position (own vehicle reference point CP) lies on a target route (#15). This determination condition obviously includes a predetermined error range, and the own position may not exactly lie on a target route. Even when the own position lies, instead of an actual travel route portion La of a target route, on an extended route portion Lb at that time, this target route is deemed to satisfy this determination condition (Yes in #15), and is selected as a guidance travel route (#51). A positional difference (same as a shortest distance MD) and a difference in direction are calculated by the deviation calculation unit 55 as a deviation between a selected guidance travel route and the own position (#52), and the calculated deviation is used for travel control by the travel control unit 50 (#53). The routine returns to Step #11 for a route search with a new own position.

If the own position (own vehicle reference point CP) does not lie on a target route in Step #15 (No in #15), a search area determination is then made as to whether an end point EP of an actual travel route portion of the target route is within a circle area of a search distance R (#20). If this search area determination is not satisfied (No in #20), a determination is made as to whether all travel route candidates have been searched (#40). As long as an unprocessed target route remains (No in #40), the routine returns to Step #14 for a selection process for a next target route. On the other hand, when all target routes have been processed (Yes in #40), the routine returns to Step #11 for a route search with a new own position. When this search area determination is satisfied (Yes in #20), a next angle determination is made (#21). This angle determination is made as to whether an angle between a straight line joining an end point EP and an own position and a travel direction of the vehicle body 1 falls within a predetermined range, or whether a search area SA includes an end point EP.

If this angle determination is not satisfied (No in #21), as long as an unprocessed target route remains (No in #40), the routine returns to Step #14 for a selection process for a next target route. On the other hand, when all target routes have been processed (Yes in #40), the routine returns to Step #11 for a route search with a new own position. When the angle determination is satisfied (Yes in #21), a node between a side Se of a search area SA and a target route is further calculated (#30), and a node determination is made as to whether the node lies on an actual travel route portion of the target route (#31). If this node determination is not satisfied (No in #31), as long as an unprocessed target route remains (No in #40), the routine returns to Step #14 for a selection process for a next target route. On the other hand, when all target routes have been processed (Yes in #40), the routine returns to Step #11 for a route search with a new own position. When the node determination is satisfied (Yes in #31), this target route is selected as a guidance travel route (#51). A positional difference (same as a shortest distance MD) and a difference in direction are calculated by the deviation calculation unit 55 as a deviation between a selected guidance travel route and the own position (#52), and the calculated deviation is used for a travel control performed by the travel control unit 50 (#53). The routine returns to Step #11 for a route search with a new own position.

### Other Exemplary Embodiments

(1) In the above described exemplary embodiment, a guidance travel route is selected based on positional relationships among an own position (own vehicle reference point CP), a search area SA, and travel route candidates (travel routes LN). However, in a simplest exemplary embodiment, a travel route candidate that is closest to an own position (own vehicle reference point) is selected as a guidance travel route.

(2) Although travel routes LN are straight lines in the above described exemplary embodiment, the travel routes LN may be curves.

(3) Although the central angle of the fan shaped search area SA is approximately 45° in the above described exemplary embodiment, a desired central angle may be set and is advantageously 180° or smaller. A search area SA having a central angle of 0° is practically handled as a straight line. Although an advantageous center point of a search area SA lies at a center of a vehicle body 1 in a width direction, and lies on a front side of the vehicle body in a travel direction, a desired center point can be set in accordance with specifications and the like of a work vehicle.

(4) The above described exemplary embodiment describes, as the work vehicle, a tractor equipped with a rotary tilling machine as the work device 30. However, in addition to such a tractor, agricultural work vehicles such as rice transplanters and combines may be adopted as exemplary embodiments.

(5) Each function unit in the functional block diagram shown in FIG. 4 is separated for description purposes. In an actual case, each function unit can be integrated with other function units, or divided into a plurality of sub-function units. Instead of the management computer 100 installed in the control center KS in the remote location, a communication terminal (such as a mobile phone or a tablet computer) held by a driver or a supervisor may be used, and one or more of the function units shown in FIG. 4 may otherwise be constructed in such a communication terminal. All function units of this field travel route generation system may obviously be constructed in a work vehicle.

### INDUSTRIAL APPLICABILITY

The embodiments of the present invention are applicable to a computer program and a computer system for searching for a guidance travel route to be set for a work vehicle travelling in a work field, and a work vehicle adopting such a route search technique. A work vehicle may travel along a travel route either manually or automatically.

According to one aspect of the present invention, a route search method for a work vehicle includes obtaining a reference position of the work vehicle. A fan shaped area spreading from a vehicle reference point in a travel direction of the work vehicle in a plan view is defined as a search area. The vehicle reference point indicates the reference position of the work vehicle. A guidance travel route along which the work vehicle is to travel and which is closest to the vehicle reference point in the search area is determined among travel route candidates stored in a memory.

According to this configuration, a plurality of travel routes set to allow a work vehicle to travel in a work field is read from the travel route storing unit, and is developed as travel route candidates in a memory or the like. One of the travel route candidates, which is closest to an own vehicle reference point of the work vehicle (typically calculated from positioning data) in a forward travel direction of the work vehicle, is selected as a guidance travel route, from among the travel route candidates in a set search area. In a fan shaped area spreading in a forward travel direction of the work vehicle, a travel route candidate which is closest to an own vehicle reference point of the work vehicle is highly likely to be a travel route that should be travelled. Even though a plurality of travel route candidates presents, a guidance travel route that should be travelled can therefore be easily and promptly selected by the above described method. A specific example of a fan shaped area spreading in a travel direction from an own vehicle reference point is a fan shaped area having a central angle of 180° or smaller around the own vehicle reference point (+90° and −90° around a center line of the travel direction), and advantageously a central angle in a range from 45° to 90° inclusive. However, a desirably settable configuration is advantageous.

To construct the above described route search program for a work vehicle, it is advantageous to form a system using the route search program and to incorporate the system into the work vehicle as a control system of the work vehicle. The embodiments of the present invention also provide a work vehicle equipped with such a route search system. The work vehicle can produce functional effects identical to the functional effects of the above described route search program.

According to an embodiment of the present invention, a route search method for a work vehicle includes calculating a reference position of the work vehicle based on positioning data. An area around a vehicle reference point in a plan view is defined as a search area. The vehicle reference point indicates the reference position. Positional relationships among travel route candidates stored in a memory, the reference position of the work vehicle, and the search area are calculated. A guidance travel route along which the work vehicle is to travel from the travel route candidates is determined based on the positional relationships.

According to this configuration, a plurality of travel routes set to allow a work vehicle to travel in a work field is read from the travel route storing unit, and is developed in a memory or the like. Positional relationships among these travel routes, an own position of the work vehicle, the search area, and the travel route candidates are calculated. Based on these positional relationships, a travel route that is currently more appropriate to a travel target is selected as a guidance travel route. A guidance travel route to actually be targeted by the work vehicle is selected from a plurality of travel route candidates. Therefore, even if the work vehicle approaches a travel route (one of the travel route candidates) along which the work vehicle should not primarily travel, due to a positional difference of the work vehicle or other reasons, an evaluation is conducted based on positional relationships among the travel route candidates, an own position, and a search area, a travel route along which the work vehicle should primarily travel is advantageously and highly likely to be selected as a guidance travel route.

Since the work vehicle normally performs work while travelling forward, a travel route appropriate as a guidance travel route is a one that lies in a travel direction of the work vehicle (a travel route along which the work vehicle should be guided currently). Since the work vehicle is however frequently turned 90° or 180° or is steered to avoid an obstruction, an angle in a travel direction of the work vehicle relative to a travel route might substantially fall within a range of ±90° around 0° (the travel route and the travel direction are in a parallel relationship). This means that a search area should cover an area in front of the own vehicle in a travel direction, i.e., a front area. However, the more an angle deviates in a horizontal direction from a center of the travel direction, the less a possibility of presence of a guidance travel route. To solve this problem, according to an advantageous exemplary embodiment of the present invention, the search area has a fan shape spreading in a travel direction of the work vehicle from the vehicle reference point. A specific example of a fan shaped area spreading in a travel direction from an own vehicle reference point in here is also a fan shaped area having a central angle of 180° or smaller around the own vehicle reference point, and advantageously a central angle in a range from 45° to 90° inclusive. However, a desirably settable configuration is advantageous. Adopting a search area having such a shape leads to a prompt, effective process of selecting a guidance travel route.

There are various positional relationships to be calculated among travel route candidates, an own position, and a search area. A more effective positional relationship needs to be adopted for precisely selecting a guidance travel route. To allow the work vehicle to travel while a center of the work vehicle lies on a travel route, positional relationships between an own vehicle reference point (for example, a center point of an own vehicle, and a center point on a front edge of an own vehicle) and travel route candidates are particularly important. When the work vehicle deviates from a travel route, positional relationships between a search area that is an area around an own vehicle reference point and travel route candidates are also important. To this end, according to another advantageous exemplary embodiment of the present invention, the positional relationships among travel route candidates, the reference position of the work vehicle, and the search area include the positional relationships between the reference position of the work vehicle and the travel route candidates and the positional relationships between the search area and the travel route candidates.

A normal travel route in the work field is a line having end points on both sides. A travel route should as required be defined as a line that is not limited with end points when taking into account some cases where the work vehicle deviates from a travel route. To this end, according to still another advantageous exemplary embodiment of the present invention, the travel route candidates include an actual travel route portion on which the work vehicle travels, and an extended route portion which is extended from the actual travel route portion, and a coordinate value of a shortest point on the actual travel route portion or the extended route portion which is nearest to the vehicle reference point in the plan view is calculated as one of the positional relationships, and whether the shortest point is located in the search area is determined as another of the positional relationships. With these features, a guidance travel route can appropriately be selected even if the work vehicle deviates from an actual travel route portion, i.e., a practical travel route.

More specifically, it may be advantageous that a travel route candidate which is the actual travel route portion having the shortest point is determined as the guidance travel route. With this selection, a process of selecting a guidance travel route can promptly be finished provided that the work vehicle correctively travels on a guidance travel route, thus process efficiency can be enhanced.

It may be also advantageous that a travel route candidate which is the extended route portion having the shortest position within the search area is determined as the guidance travel route. Since, even if the work vehicle deviates from an actual travel route portion of a guidance travel route, the work vehicle can reach the actual travel route portion provided that the work vehicle keeps travelling with that state, selecting the travel route candidate as a guidance travel route at this point is effective.

To construct the above described route search program for a work vehicle, it is advantageous to form a system using the route search program and to incorporate the system into the work vehicle as a control system of the work vehicle. The embodiments of the present invention also provide such a route search system. More specifically, according to an embodiment of the present invention, a route search system for a work vehicle includes circuitry. The circuitry is configured to calculate a reference position of the work vehicle based on positioning data. The circuitry is configured to define, as a search area, an area around a vehicle reference point in a plan view, the vehicle reference point indicating the reference position of the work vehicle. The circuitry is configured to calculate positional relationships among travel route candidates stored in a memory, the reference position of the work vehicle, and the search area. The circuitry is configured to determine a guidance travel route along which the work vehicle is to travel from the travel route candidates based on the positional relationships. The circuitry is configured to calculate a deviation between the guidance travel route and the reference position. The route search system can produce functional effects identical to the functional effects of the above described route search program, and can adopt the above described various exemplary embodiments.

The embodiments of the present invention also provide a work vehicle incorporated with this route search program or route search system. More specifically, according to an embodiment of the present invention, a work vehicle includes a memory to store travel routes, and circuitry. The circuitry is configured to calculate a reference position of the work vehicle based on positioning data. The circuitry is configured to define, as a search area, an area around a vehicle reference point in a plan view. The vehicle reference point indicates the reference position of the work vehicle. The circuitry is configured to calculate positional relationships among the travel routes, the reference position of the work vehicle, and the search area. The circuitry is configured to determine a guidance travel route along which the work vehicle is to travel from the travel routes based on the positional relationships. The circuitry is configured to calculate a deviation between the guidance travel route and the reference position of the work vehicle. The work vehicle can produce functional effects identical to the functional effects of the above described route search program, and can adopt the above described various advantageous exemplary embodiments.

A work vehicle can be steered and travelled either manually or automatically in a work field along a guidance travel route. In a work vehicle to be steered automatically, the circuitry is further configured to steer the work vehicle based on the deviation so that the work vehicle travels along the guidance travel route. In a work vehicle to be steered manually, the circuitry is further configured to provide a notification of steering guidance information based on the deviation so that the work vehicle travels along the guidance travel route.

Obviously, numerous modifications and variations of the present invention are possible in light of the above teachings. It is therefore to be understood that within the scope of the appended claims, the invention may be practiced otherwise than as specifically described herein.

What is claimed is:

1. A route search system for a work vehicle, comprising:
a receiver to obtain a reference position of the work vehicle;
a processor to define, as a search area, an area around a vehicle reference point in a plan view, the vehicle reference point indicating the reference position of the work vehicle; and
a controller to determine a guidance travel route along which the work vehicle is to travel and which is closest to the vehicle reference point in the search area among travel route candidates stored in a memory.

2. A work vehicle comprising:
a memory to store travel routes;
a position calculator to calculate a reference position of work vehicle based on positioning data;
a processor to define as a search area, an area around a vehicle reference point in a plan view, the vehicle reference point indicating the reference position of the work vehicle;
a controller to determine a guidance travel route along which the work vehicle is to travel and which is closest to the vehicle reference point in the search area among travel routes stored in the memory; and
a deviation calculator to calculate a deviation between the guidance travel route and the reference position.

3. The work vehicle according to claim 2, further comprising:
a travelling controller to steer the work vehicle based on the deviation so that the work vehicle travels along the guidance travel route.

4. The work vehicle according to claim 2, further comprising:
a notification generator to provide a notification of steering guidance information based on the deviation so that the work vehicle travels along the guidance travel route.

5. A route search method for a work vehicle, comprising:
obtaining a reference position of the work vehicle;
defining, as a search area, an area around a vehicle reference point in a plan view, the vehicle reference point indicating the reference position of the work vehicle;
calculating positional relationships among travel route candidates stored in a memory, the reference position of the work vehicle, and the search area; and
determining a guidance travel route along which the work vehicle is to travel from the travel route candidates based on the positional relationships.

6. The route search method according to claim 5, wherein the search area has a fan shape spreading in a travel direction of the work vehicle from the vehicle reference point.

7. The route search method according to claim 5, wherein the positional relationships among travel route candidates, the reference position of the work vehicle, and the search area include the positional relationships between the reference position of the work vehicle and the travel route candidates and the positional relationships between the search area and the travel route candidates.

8. The route search method according to claim 5,
wherein the travel route candidates include an actual travel route portion on which the work vehicle travels, and an extended route portion which is extended from the actual travel route portion, and
wherein a coordinate value of a shortest point on the actual travel route portion or the extended route portion which is nearest to the vehicle reference point in the plan view is calculated as one of the positional relationships, and whether the shortest point is located in the search area is determined as another of the positional relationships.

9. The route search method according to claim 8, wherein a travel route candidate which is the actual travel route portion having the shortest point is determined as the guidance travel route.

10. The route search method according to claim 9, wherein a travel route candidate which is the extended route portion having the shortest position within the search area is determined as the guidance travel route.

11. A non-transitory computer-readable storage medium having program code stored therein which, when executed by a computer, causes the computer to perform a route search method for a work vehicle, the route search method comprising:
obtaining a reference position of the work vehicle;
defining, as a search area, an area around a vehicle reference point in a plan view, the vehicle reference point indicating the reference position of the work vehicle; and
determining a guidance travel route along which the work vehicle is to travel and which is closest to the vehicle reference point in the search area among the travel route candidates stored in a memory.
